(19) United States
(12) Patent Application Publication
(10) Pub. No.: US 2026/0113374 A1
(43) Pub. Date: Apr. 23, 2026

(54) MULTICAST-BASED FORWARDING FOR DISTRIBUTED GATEWAY

(71) Applicant: HEWLETT PACKARD ENTERPRISE DEVELOPMENT LP, Spring, TX (US)

(72) Inventors: Tathagata Nandy, Bangalore (IN); Thimma Reddy Gadekal, Bangalore (IN); Somnath Bhimaram Lohar, Bangalore (IN)

(21) Appl. No.: 19/062,920

(22) Filed: Feb. 25, 2025

(30) Foreign Application Priority Data
Oct. 18, 2024 (IN) 202441079254

(51) Int. Cl. H04L 67/104; H04L 47/33; H04L 65/102; H04L 69/22

(52) U.S. Cl. CPC H04L 67/1046; H04L 47/33; H04L 65/102; H04L 69/22; H04L 2212/00

(57) ABSTRACT

In an overlay network, a network device can join a multicast group in an underlay network of the overlay network. Here, a gateway IP address can be allocated to a plurality of gateways of the overlay network. Furthermore, the multicast group can be associated with a multicast IP address and can include the plurality of gateways. The network device can then receive, from a client device, a packet with the gateway IP address as a destination address. The network device can then encapsulate the packet with an encapsulation header with the multicast IP address as a destination address. Subsequently, the network device can forward the encapsulated packet via a multicast tree in the underlay network.

### BACKGROUND

A network device, such as a switch, may support different protocols and services. For example, the network device can support an overlay network formed based on tunneling and virtual private networks (VPNs). The network device can then facilitate overlay routing for a VPN over the tunnels.

### BRIEF DESCRIPTION OF THE FIGURES

FIG. 1 illustrates an example of an overlay network supporting efficient multicast-based forwarding for a distributed gateway, in accordance with an aspect of the present application.

FIG. 2 illustrates an example of multicast-based distribution of a packet destined to a distributed gateway, in accordance with an aspect of the present application.

FIG. 3A presents a flowchart illustrating an example of a process of a network device efficiently forwarding a packet destined to a distributed gateway in an overlay network, in accordance with an aspect of the present application.

FIG. 3B presents a flowchart illustrating an example of a process of a network device sending an encapsulated packet via a multicast interface, in accordance with an aspect of the present application.

FIG. 4A presents a flowchart illustrating an example of a process of a network device responding to a request packet, in accordance with an aspect of the present application.

FIG. 4B presents a flowchart illustrating an example of a process of a network device determining whether a packet matches a predetermined packet type, in accordance with an aspect of the present application.

FIG. 5 presents a flowchart illustrating an example of a process of a network device receiving a packet destined to a multicast group associated with the multicast group, in accordance with an aspect of the present application.

FIG. 6 illustrates an example of a computing system facilitating efficient multicast-based forwarding for a distributed gateway, in accordance with an aspect of the present application.

FIG. 7 illustrates an example of a computer-readable medium (CRM) facilitating efficient multicast-based forwarding for a distributed gateway, in accordance with an aspect of the present application.

In the figures, like reference numerals refer to the same figure elements.

### DETAILED DESCRIPTION

Multicast technology plays a crucial role in various Internet applications, allowing efficient content distribution from a single source to multiple hosts through network devices such as switches and routers. This method of data transmission significantly enhances network performance by optimizing bandwidth usage and reducing redundant traffic. To facilitate the distribution of multicast content across a network, network-layer multicast protocols are employed. One commonly used protocol is Protocol-Independent Multicast (PIM), which constructs and maintains multicast distribution trees to ensure efficient delivery of content to all intended recipients. Hosts wishing to receive traffic from a specific multicast group can initiate the process by sending a client join request to an upstream network device. This join request can take the form of an Internet Group Management Protocol (IGMP) request in IPV4 networks or a Multicast Listener Discovery (MLD) request in IPV6 networks. The network device that receives this join request is referred to as the requesting network device.

In the multicast distribution process, the requesting network device can send a network join request (e.g., a PIM join request) to a source network device coupled to the source of the multicast group. Upon receiving this request, the source network device begins forwarding multicast traffic to the requesting network device, establishing a path for content distribution. In more advanced network configurations, the network devices may operate in an overlay network. This overlay network is typically formed using overlay routing techniques for a Virtual Private Network (VPN) across a set of tunnels. One example of overlay network is the deployment of an Ethernet VPN (EVPN) as an overlay on top of a set of Virtual Extensible Local Area Networks (VXLANs). Within this overlay fabric architecture, communication between a pair of network devices within a fabric occurs through a dedicated tunnel between the two. Consequently, each network device within the overlay network functions as a tunnel endpoint. This tunneling mechanism provides a secure and efficient means of transmitting data across the network. In the context of multicast traffic, both the control messages and the actual data for the multicast group are forwarded via the established tunnel between the requesting network device and the source network device. This approach ensures that multicast traffic is efficiently distributed across the overlay network while maintaining the benefits of the underlying VPN infrastructure.

To deploy a VPN over the tunnels, a respective tunnel endpoint may map a respective client virtual local area network (VLAN) to a corresponding tunnel network identifier (TNI), which can identify a virtual network for a tunnel. The TNI may appear in an encapsulation header (e.g., a tunnel header) that encapsulates a packet and is used to forward the encapsulated packet via a tunnel. For example, if the tunnel is formed based on VXLAN, the TNI can be a virtual network identifier (VNI) of a VXLAN header, and a tunnel endpoint can be a VXLAN tunnel endpoint (VTEP). A TNI can also be mapped to the virtual routing and forwarding (VRF) associated with the tunnels if layer-3 routing and forwarding are needed. A VPN can be distributed across an overlay network. An overlay network with a VPN can also be referred to as a distributed tunnel fabric. Since the fabric is an overlay network, a respective network device in the fabric can be a tunnel endpoint of one or more tunnels. To deploy a Virtual Private Network (VPN) over tunnels, each tunnel endpoint employs a sophisticated mapping system. This system associates a client virtual local area network (VLAN) with a corresponding tunnel network identifier (TNI). The TNI serves as a unique identifier for a virtual network within a tunnel, playing a crucial role in the encapsulation process. When a packet is prepared for transmission through the tunnel, the TNI is incorporated into an encapsulation header, often referred to as a tunnel header. This header wraps around the original packet, providing essential information for routing the encapsulated data through the appropriate tunnel. In scenarios where Virtual Extensible LAN (VXLAN) is used to form the tunnel, the TNI takes the form of a virtual network identifier (VNI) within the VXLAN header. In this context, the tunnel endpoint functions as a VXLAN tunnel endpoint (VTEP), managing the encapsulation and decapsulation of packets at either end of the tunnel. For networks requiring layer-3 routing and forwarding capabilities, the TNI can be further mapped to a virtual routing and forwarding (VRF) instance associated with the tunnels. This mapping enables more complex routing decisions and network segmentation. The VPN can extend across an entire overlay network, creating a distributed tunnel fabric. In this fabric architecture, each network device can serve as a tunnel endpoint for one or more tunnels, forming a cohesive and flexible network environment.

The aspects described herein address the problem of distributing packets destined to a distributed gateway of an overlay network by (i) associating a multicast group representing the distributed gateway with a plurality of network devices of the distributed gateway; and (ii) if a packet is to be distributed to the plurality of network devices, encapsulating the packet with an encapsulation header corresponding to the multicast group. Here, a respective network device in the distributed gateway can be referred to as a gateway device. Since the gateway devices of the overlay network are associated with the multicast group, the packet can be efficiently distributed to the gateway devices via a multicast tree of the multicast group.

An overlay network, such as a distributed tunnel fabric (i.e., an overlay network with a VPN), can be formed when multiple network devices are coupled to each other via corresponding tunnels. In the underlying (or underlay) network of the overlay network, a respective network device can establish a route to every other network device. The network device can use a routing protocol, such as the Border Gateway Protocol (BGP), to establish the route.

Currently, in the overlay network, a plurality of gateway devices can be configured as a distributed gateway via which the client devices can be coupled to the overlay network. A gateway device associated with the distributed gateway can be allocated with the same Internet Protocol (IP) address so that a client device can be coupled to any of these endpoints and use the same gateway IP address. The gateway IP address can be configured as the default gateway address on the client devices coupled to the overlay network. In some examples, a Dynamic Host Configuration Protocol (DHCP) server associated with the overlay network may advertise the gateway IP address as the default IP address to the client devices.

During operation, the client device can generate a packet with a source IP address associated with the client device. To forward the packet, the client device can send an Address Resolution Protocol (ARP) request corresponding to the gateway IP address. Since the gateway IP address is shared among the gateway devices, the gateway device coupled to the client device can send an ARP response with a media access control (MAC) address of the gateway device. The client device can then forward the packet to the gateway device based on the received MAC address of the gateway device. Subsequently, the gateway device may forward the packet to another endpoint of the overlay network by encapsulating the packet with an encapsulation header and forwarding the encapsulated packet via a corresponding tunnel. In this way, the gateway device can receive packets from the client devices and forward them via the overlay network.

However, if the gateway device sends a packet to a client device coupled to another gateway device, the source address of the packet can be the gateway IP address. For example, if the gateway device sends a ping packet to the client device, the source address of the ping packet can be the gateway IP address. Consequently, the client device may send a response packet to the gateway IP address. Because the gateway IP address is associated with the plurality of gateway devices, the response packet may arrive at another gateway device, thereby not reaching the correct destination.

Furthermore, when a packet is forwarded via a tunnel, the packet is encapsulated with an encapsulation header and forwarded via the corresponding route in the underlay network. Hence, to forward a multi-destination packet, such as an ARP request packet, a gateway device can replicate the packet for a respective tunnel, encapsulate the replicated packet with a tunnel encapsulation header associated with the tunnel, and forward the encapsulated packet via the tunnel. The multi-destination packet can be a broadcast, unknown unicast, or multicast packet. Since the replication and forwarding are repeated for the tunnels to other network devices in the overlay network, the distribution of a multi-destination packet in the overlay network can be inefficient.

To address this issue, a respective gateway device of the overlay network can be associated with a dedicated multicast group of the underlay network of the overlay network. Multicast traffic associated with the multicast group can be distributed via a multicast tree in the underlay network. As a result, instead of replicating a multi-destination packet for individual tunnels, the packet can be forwarded via the multicast tree in the underlay network, thereby efficiently forwarding the packet. If the network is a spine and leaf network, a set of leaf devices can be coupled to another set of spine devices in a tree topology. The spine devices typically facilitate communication among the leaf devices. The leaf devices can be coupled to client devices and receive traffic from them. Therefore, the gateway devices can be leaf devices. The spine devices can then operate as aggregation devices that can aggregate traffic from one or more leaf devices. In addition to operating as an aggregation device, a spine device may couple client devices as well.

In an overlay network, the leaf devices can be the overlay network devices (i.e., tunnel endpoints). The spine devices can be the underlay devices participating in the routing protocol of the underlay network (e.g., using respective BGP instances). The leaf devices can also be in the underlay network and participate in the routing protocol of the underlay network. Because both spine and leaf devices can participate in the routing protocol, the forwarding paths of the tunnels of the overlay network can span both spine and leaf devices in the underlay network. Therefore, the spine devices can be the underlay network devices via which the tunnels are established.

For example, when a leaf device receives a packet from a client device, the leaf device can encapsulate the packet with a tunnel encapsulation header and forward the encapsulated packet via a corresponding tunnel in the overlay network. The leaf device can forward the encapsulated packet to a spine device via a corresponding path in the underlay network. The spine device can then forward the encapsulated packet toward the destination (i.e., the other endpoint of the tunnel) based on the encapsulation header (e.g., an outer IP address of the encapsulation header). In this way, the encapsulated packet is forwarded via the underlay network between two endpoints of the overlay network. Since the traffic of the overlay network can be distributed via the spine devices, one of the spine devices can be configured as the RP of the multicast group.

The gateway IP address can be allocated to a respective gateway device (e.g., by an administrator). When a gateway device determines that it is associated with the gateway IP address (e.g., based on the allocation), the gateway device can send a join request (e.g., a PIM join) to the RP of the multicast group in the underlay network, thereby joining the corresponding multicast tree in the underlay network. Furthermore, the multicast IP address of the multicast group can be allocated to the gateway device. Consequently, the multicast IP address can be a local address of the gateway device. Because the gateway device joins the multicast tree, the gateway device can also configure an interface associated with the multicast group in the forwarding hardware.

When a gateway device detects the gateway IP address as the destination address of a packet, the gateway device can determine whether the packet corresponds to a packet type that is to be distributed to all gateway devices. A respective gateway device may be preconfigured with a list of packet types. Examples of such packet types can include, but are not limited to, ARP responses, ping packets (e.g., Internet Control Message Protocol (ICMP) echo and reply packets), PIM register requests and responses, PIM candidate RP advertisements, traceroute packets, and path maximum transmission unit (MTU) discovery packets. If the packet corresponds to one of these packet types (i.e., the type of the packet matches one of these packet types), the gateway device can determine that the packet is to be distributed to all other gateway devices. The gateway device can then encapsulate the packet with an encapsulation header (e.g., a tunnel header) and set the multicast IP address of the multicast group as the destination address.

The gateway device can then send the encapsulated packet via the interface. Accordingly, the encapsulated packet is forwarded via the multicast tree in the underlay network. For example, since a respective gateway device can join the multicast group by sending a multicast join request for the multicast group to the RP, the RP can be aware of the gateway devices that are to receive packets of the multicast group. Accordingly, when the RP receives the encapsulated packet, the RP can determine the number of other members in the multicast group (i.e., the other gateway devices) and replicate the encapsulated packet accordingly. The RP can then forward a copy of the encapsulated packet to the other gateway devices via the multicast tree. When another gateway device receives the encapsulated packet, the gateway device can determine that the destination address of the encapsulation header is the multicast address. Since the multicast address is allocated to the gateway device, it can decapsulate the encapsulation header and obtain the packet. On the other hand, if the packet does not correspond to one of the packet types, the packet may not be distributed to other gateway devices. Accordingly, the network device can process the packet based on the destination IP address of the packet. In this way, the gateway devices can efficiently forward packets using multicast to the other gateway devices.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to a client device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

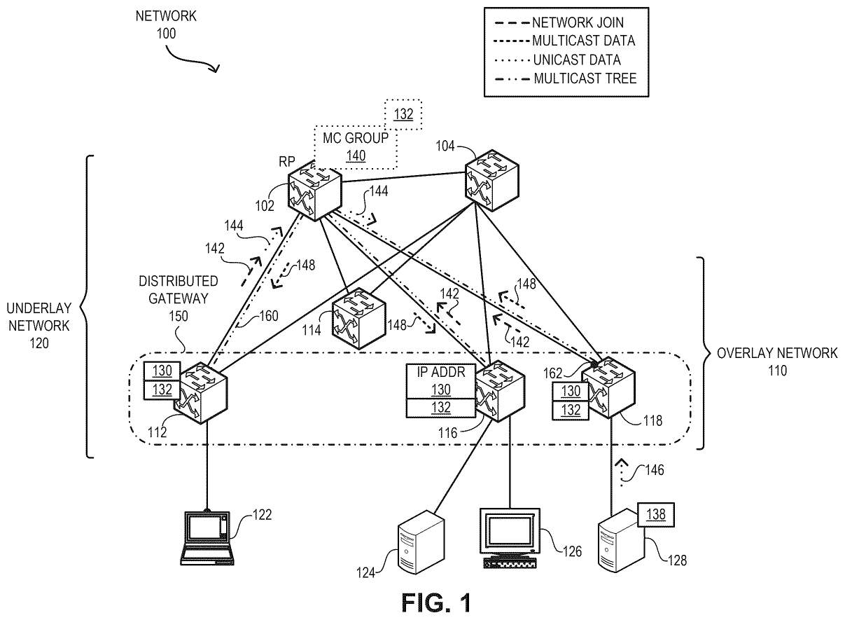

FIG. 1 illustrates an example of an overlay network supporting efficient multicast-based forwarding for a distributed gateway, in accordance with an aspect of the present application. A network 100 can include a number of network devices (e.g., switches), and may include heterogeneous network components, such as layer-2 and layer-3 hops, and tunnels. In some examples, network 100 can be an Ethernet network, InfiniBand network, or other network, and may use a corresponding communication protocol, such as IP, FibreChannel over Ethernet (FCOE), or other protocol. Network 100 can include a number of network devices 102, 104, 112, 114, 116, and 118. A respective network device in network 100 can be associated with a MAC address and an IP address and can include at least one processing resource. Examples of a processing resource can include, but are not limited to, a processor core, a graphics processing unit (GPU), and a tensor processing unit (TPU). The network device can also include at least one non-transitory computer-readable medium storing instructions that, when executed by the processing resource, causes the processing resource to perform one or more operations. The network device can further include forwarding hardware (e.g., the application-specific integrated circuit (ASIC) of the network device). Client devices 122 and 128 (e.g., user devices or servers) can be coupled to network devices 112 and 118, respectively. Furthermore, client devices 124 and 126 can be coupled to network device 116.

Network devices 112, 114, 116, and 118 can be in an overlay network 110, which can be a distributed tunnel fabric, where the network devices can be coupled to each other via tunnels. In overlay network 110, tunnel encapsulation is initiated and terminated within overlay network 110. Network devices in overlay network 110 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). A VPN, such as an EVPN, can be deployed over overlay network 110. The tunnels in overlay network 110 can be formed over an underlay network 120. Underlay network 120 can be a physical network, and a respective link of underlay network 120 can be a physical link.

A respective network device in overlay network 110 can also be in underlay network 120. Here, a network device operating as a tunnel endpoint can also be in underlay network 120. A respective pair of network devices in underlay network 120 can be a BGP peer. Therefore, in underlay network 120, a respective network device can use BGP to establish routes via which packets are forwarded. Accordingly, the encapsulated packets of overlay network 110 can be forwarded via these routes in underlay network 120. In some examples, network 100 can be a spine and leaf network wherein network devices 112, 114, 116, and 118 can be leaf devices, and network devices 102 and 104 can be spine devices. Here, leaf devices 112, 114, 116, and 118 can be in overlay network 110 as tunnel endpoints. On the other hand, spine devices 102 and 104 can be in underlay network 120 via which the tunnels of overlay network 110 are established. Under such a spine-and-leaf network topology, spine devices 102 and 104 can operate as aggregation devices that can aggregate traffic from leaf devices 112, 114, 116, and 118.

In overlay network 110, network devices 112, 116, and 118 can be gateway devices of a distributed gateway 150. Therefore, client devices 122, 124, 126, and 128 are coupled to these gateway devices of distributed gateway 150. Gateway devices 112, 116 and 118 can be associated with a same IP address 130. As a result, regardless of which gateway device it is connected to, each of client devices 122, 124, 126, and 128 can be configured with IP address 130 as the default gateway address. A DHCP server in network 100 (not shown in FIG. 1) may advertise IP address 130 as the default IP address to client devices 122, 124, 126, and 128.

To send a packet, client device 122 can send an ARP request for IP address 130. Gateway device 112 can receive the ARP request and send an ARP response comprising the MAC address of gateway device 112. Similarly, when client device 124 sends an ARP request for IP address 130, gateway device 116 can send an ARP response comprising the MAC address of gateway device 116. Therefore, a respective gateway device can respond to an ARP request using its local MAC address. Client device 122 can then forward the packet to gateway device 112 based on its MAC address. Gateway device 112 may forward the packet to another endpoint, such as gateway device 118 by encapsulating the packet with an encapsulation header and forwarding the encapsulated packet via a corresponding tunnel between gateway devices 112 and 118. In the same way, gateway device 116 can forward packets from client device 124 via overlay network 110. In this way, gateway devices 112, 116, and 118 can receive packets from the corresponding client devices and forward them via overlay network 110.

If gateway device 112 sends a packet 144 to client device 128, the source address of packet 144 can be IP address 130. Consequently, client device 128 may send a response packet 146 with IP address 130 as a destination address. Packet 146 can include IP address 138 of client device 128 as the source address. Because IP address 130 is associated with gateway devices 112, 116, and 118, packet 146 may return to gateway device 116 or 118 instead of its correct destination, gateway device 112. Furthermore, when a packet is forwarded via a tunnel, the packet is encapsulated with an encapsulation header and forwarded via underlay network 120. Hence, to forward a multi-destination packet from network device 128, gateway device 118 can replicate the packet for tunnels to gateway devices 112 and 116, encapsulate the replicated packet with a tunnel encapsulation header associated with the tunnel, and forward the encapsulated packet via the tunnel. Since the replication and forwarding are repeated for the tunnels to other gateway devices in overlay network 110, the distribution of a multi-destination packet in overlay network 110 can be inefficient.

To address this issue, the gateway devices in distributed gateway 150 can be associated with a dedicated multicast group 140 in underlay network 120. Multicast traffic associated with multicast group 140 can be distributed via a multicast tree in underlay network 120. If network 100 is a spine and leaf network, network devices 112, 114, 116, and 118 can be leaf devices coupled to spine devices 102 and 104 in a tree topology. Spine devices 102 and 104 typically facilitate communication among leaf devices 112, 114, 116, and 118. Therefore, one of spine devices 102 and 104 can be the RP for multicast group 140. In this example, leaf devices 112, 116, and 118 can be gateway devices, and spine device 102 can be the RP. Spine devices 102 and 104 can then operate as aggregation devices that can aggregate traffic from gateway devices 112, 116, and 118.

When gateway devices 112, 116, and 118 determine that they are associated with gateway IP address 130, gateway devices 112, 116, and 118 can send a join request 142 (e.g., a PIM join) to network device 102 to join multicast group 140. In this way, gateway devices 112, 116, and 118 can join multicast tree 160 in underlay network 120. Furthermore, multicast IP address 132 of multicast group 140 can be allocated to the gateway device. Consequently, multicast IP address 232 can be a local address of gateway devices 112, 116, and 118. Because gateway devices 112, 116, and 118 join multicast tree 160, each of gateway devices 112, 116, and 118 can also configure an interface associated with multicast group 140 in its forwarding hardware. For example, gateway device 118 can configure an interface 162 for multicast group 140 in its forwarding hardware.

When gateway device 118 detects IP address 130 as the destination address of packet 146, gateway device 118 can determine whether packet 146 corresponds to a packet type that is to be distributed to gateway devices 112 and 116. Gateway device 118 may be preconfigured with a list of packet types (e.g., ARP responses and ping packets) that can be forwarded via multicast tree 160. This list can be configurable and predetermined by an administrator. If packet 146 corresponds to one of these packet types, gateway device 118 can determine that packet 146 is to be distributed to gateway devices 112 and 116. Gateway device 118 can then encapsulate packet 146 with an encapsulation header (e.g., a tunnel header) to generate encapsulated multicast packet 148. The encapsulation header can include IP address 132 as the destination address of the encapsulation header.

Gateway device 118 can then send packet 148 via interface 162. Accordingly, packet 148 is forwarded via multicast tree 160 in underlay network 120. For example, when network device 102 receives packet 148, network device 102 can determine that gateway devices 112 and 116 are on multicast tree 160. Therefore, network device 102 can replicate packet 148 and forward respective copies of packet 148 to gateway devices 112 and 116 via multicast tree 160. When gateway device 112 receives packet 148, gateway device 112 can determine that the destination address of the encapsulation header is multicast IP address 132. Since multicast IP address 132 is allocated to gateway device 112, gateway device 112 can decapsulate the encapsulation header and obtain packet 146. Similarly, upon receiving packet 148, gateway device 116 can decapsulate the encapsulation header and obtain packet 146. In this way, gateway device 118 can efficiently forward packets using multicast to gateway devices 112 and 116.

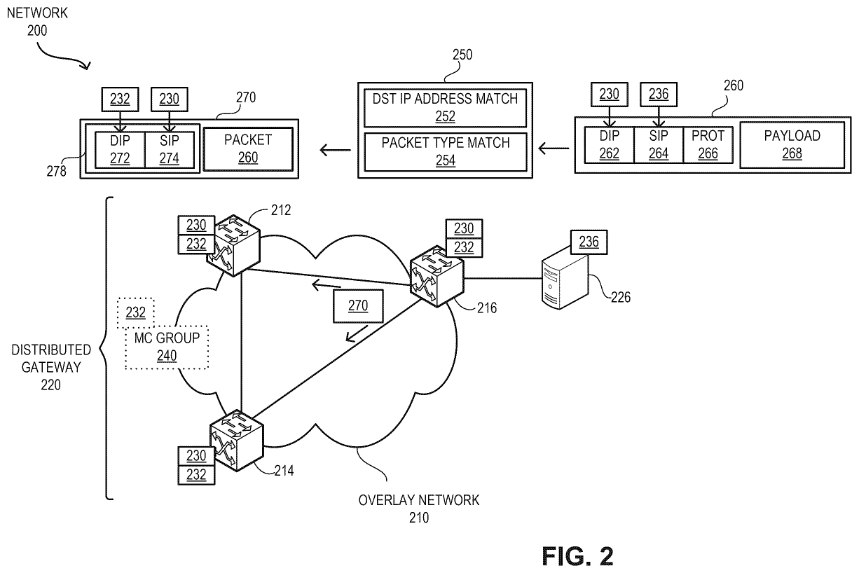

FIG. 2 illustrates an example of multicast-based distribution of a packet destined to a distributed gateway, in accordance with an aspect of the present application. A network 200 can include a number of network devices (e.g., switches), and may include heterogeneous network components, such as layer-2 and layer-3 hops, and tunnels. In some examples, network 200 can be an Ethernet network, InfiniBand network, or other network, and may use a corresponding communication protocol, such as IP, FCOE, or other protocol. Network 200 can include a number of network devices 212, 214, and 216. A respective network device in network 200 can be associated with a MAC address and an IP address. Client device 226 can be coupled to network device 216.

Network devices 212, 214, and 216 can be in an overlay network 210, which can be a distributed tunnel fabric, where the network devices can be coupled to each other via tunnels. Examples of a tunnel can include, but are not limited to, VXLAN, GRE, NVGRE, Geneve, IPsec, and MPLS. A VPN, such as an EVPN, can be deployed over overlay network 210. The tunnels in overlay network 210 can be formed over an underlay network. The underlay network can be a physical network, and a respective link of the underlay network can be a physical link. In overlay network 210, network devices 212, 214, and 216 can be gateway devices of a distributed gateway 220.

Gateway devices 212, 214, and 216 can be associated with the same IP address 230. As a result, regardless of which gateway device it is connected to, client device 226 can be configured with IP address 230 as the default gateway address. A DHCP server in network 200 (not shown in FIG. 1) may advertise IP address 230 as the default IP address to client device 226. When gateway devices 212, 214, and 216 determine that they are associated with gateway IP address 230, gateway devices 212, 214, and 216 can join a multicast group 240, which can be reserved for distributing packets within distributed gateway 220. Multicast IP address 232 of multicast group 240 can then be allocated to gateway devices 212, 214, and 216. Consequently, multicast IP address 232 can be a local address of gateway devices 212, 214, and 216.

During operation, client device 226 can send a packet 260 with a destination IP address 262 and a source IP address 264. Since packet 260 is sent from client device 226, source IP address 264 can include IP address 236 of client device 226. If packet 260 is destined to the distributed gateway, destination IP address 262 can include IP address 230. Packet 260 can also include protocol information 266, which indicates a packet type of packet 260. Packet 260 may also include a payload 268. If packet 260 is a ping response, protocol information 266 can indicate an ICMP reply. Payload 268 may then include a timestamp and a sequence number of the ping response. Similarly, if packet 260 facilitates MAC address resolution, protocol information 266 can indicate an ARP response. Payload 268 may then include the MAC address of client device 226. Gateway device 216 can use a packet inspection tool, such as Wireshark, to determine the packet type from protocol information 266.

Gateway device 216 can receive packet 260 and check packet 260 against a set of conditions 250. First, gateway device 216 can determine whether destination IP address 262 matches gateway IP address 230 (condition 252). If gateway device 216 detects a match, gateway device 216 can determine whether the packet type indicated in protocol information 266 corresponds to a list of predetermined packet types (condition 254). Examples of the predetermined packet types can include, but are not limited to, ARP responses, ping packets, PIM register requests and responses, PIM candidate RP advertisements, traceroute packets, and path MTU discovery packets. If packet 260 corresponds to one of these packet types (i.e., the packet type of packet 260 matches one of these packet types), gateway device 216 can determine that conditions 250 are satisfied. Accordingly, gateway device 216 can determine that packet 260 is to be distributed to gateway devices 212 and 214.

Gateway device 216 can then encapsulate packet 260 with an encapsulation header 278 (e.g., a tunnel header) to generate encapsulated multicast packet 270. If the tunnels in overlay network 210 are formed using VXLAN tunnels, encapsulation header 278 can be a VXLAN header. Encapsulation header 278 can include a destination IP address 272 and a source IP address 274. Since packet 270 is sent from gateway device 216, source IP address 274 can include gateway IP address 230. Furthermore, destination IP address 272 can include multicast IP address 232 because packet 270 can be distributed to gateway devices 212 and 214 of multicast group 240. Gateway device 216 can then forward packet 270 to gateway devices 212 and 214 via respective tunnels.

When gateway device 212 receives packet 270, gateway device 212 can determine that destination address 272 of encapsulation header 278 is multicast IP address 232. Since multicast IP address 232 is allocated to gateway device 212, gateway device 212 can decapsulate encapsulation header 278 and obtain packet 260. Similarly, upon receiving packet 270, gateway device 214 can decapsulate encapsulation header 278 and obtain packet 260. In this way, gateway device 216 can efficiently forward packets over multicast group 240 to gateway devices 212 and 214.

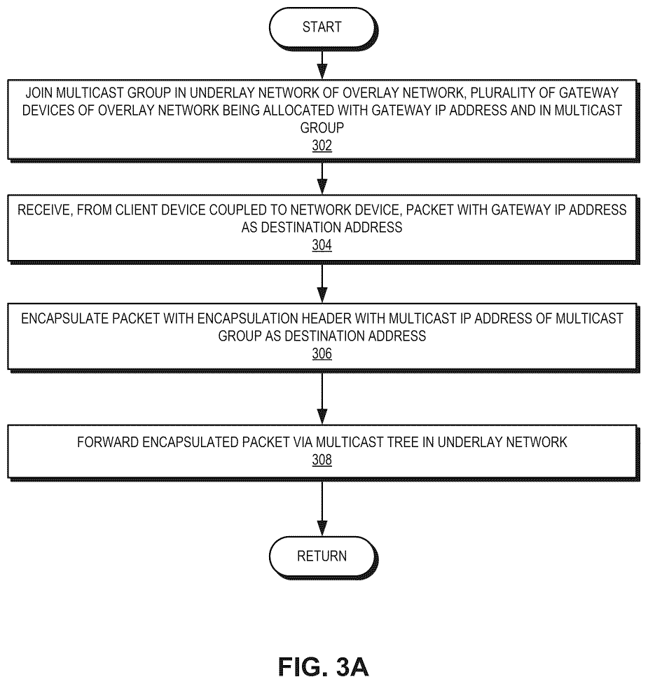

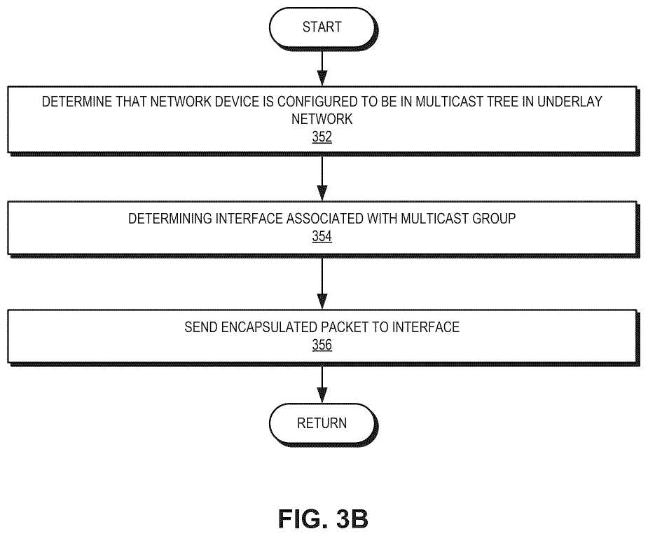

FIG. 3A presents a flowchart illustrating an example of a process of a network device efficiently forwarding a packet destined to a distributed gateway in an overlay network, in accordance with an aspect of the present application. During operation, the network device can join a multicast group in the underlay network of an overlay network (operation 302). The overlay network can include a plurality of gateway devices, which can each be allocated with a gateway IP address. The plurality of gateway devices can also be the multicast group. In the example in FIG. 1, each of gateway devices 112, 116, and 118 of overlay network 110 can be allocated with the same gateway IP address 130. Network device 118 can then join multicast group 140 reserved for distributing traffic in distributed gateway 150.

The network device can then receive, from a client device coupled to the network device, a packet with a gateway IP address as a destination address (operation 304). Here, the packet can be destined to a gateway device. In the example in FIG. 1, network device 118 can receive packet 146 from client device 128. The destination address of packet 146 can be gateway IP address 130. The network device can then encapsulate the packet with an encapsulation header with a multicast IP address of the multicast group as the destination address (operation 306). Since a respective gateway device of the overlay network can be associated with the multicast group, a packet destined to the multicast IP address can then be forwarded to a respective other gateway device. In the example in FIG. 1, network device 118 can encapsulate packet 146 with an encapsulation header to generate encapsulated packet 148. The destination address of the encapsulation header can then include IP address 132 of multicast group 140.

The network device can then forward the encapsulated packet via a multicast tree in the underlay network (operation 308). Because a respective gateway device of the overlay network can be associated with the multicast group, the gateway device can be part of the multicast tree. As a result, when the encapsulated packet is forwarded via the multicast tree, other gateway devices can receive the encapsulated packet. In the example in FIG. 1, gateway device 118 can forward encapsulated packet 148 via multicast tree 160. Gateway devices 112 and 116 can then receive encapsulated packet 148.

FIG. 3B presents a flowchart illustrating an example of a process of a network device sending an encapsulated packet via a multicast interface, in accordance with an aspect of the present application. During operation, the network device can determine that the network device is configured to be in a multicast tree in the underlay network (operation 352). An administrator can allocate the gateway IP address to a respective gateway device of a network. Accordingly, if the network device determines that it is configured with the gateway IP address (i.e., based on the allocation), the network device can determine that it is to join the multicast tree. Accordingly, the network device can send a join request to the multicast group of the multicast tree. In the example in FIG. 1, upon determining its association with gateway IP address 130, gateway device 118 can send a join request 142 to multicast group. Accordingly, gateway device 118 can become associated with multicast tree 160.

The network device can then determine an interface associated with the multicast group (operation 354). The interface can be a multicast interface associated with the multicast tree. Therefore, if a packet is forwarded via the interface, the packet can be forwarded via the multicast tree. In the example in FIG. 1, upon determining its association with gateway IP address 130, gateway device 118 can determine interface 162 associated with multicast tree 160. The network device can then send the encapsulated packet to the interface (operation 356). The interface can be an outgoing interface associated with the multicast group. As a result, the network device can forward the encapsulated packet to the interface. In the example in FIG. 1, gateway device 118 can forward encapsulated packet 148 to interface 162.

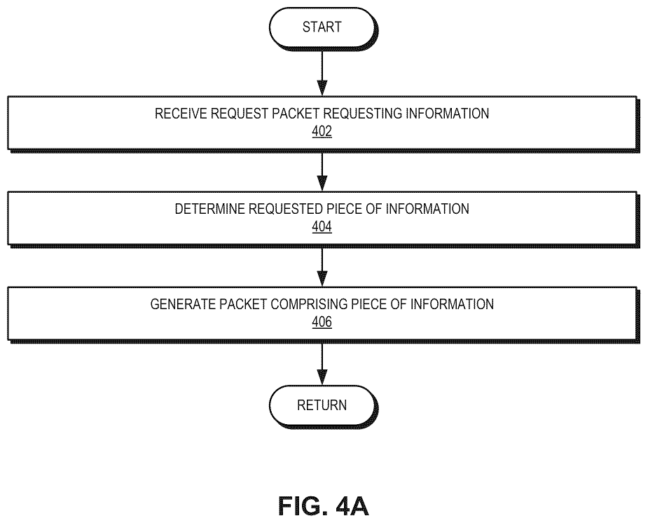

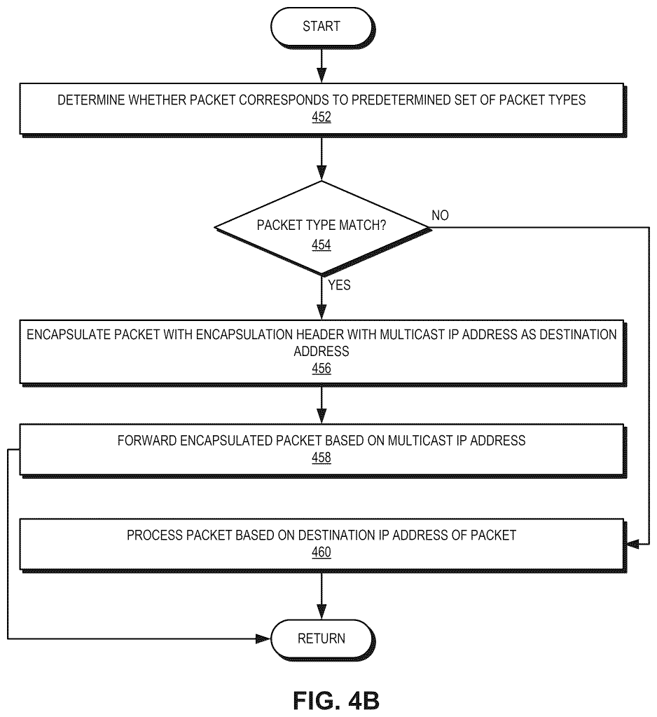

FIG. 4A presents a flowchart illustrating an example of a process of a network device responding to a request packet, in accordance with an aspect of the present application. During operation, the network device can receive a request packet requesting information (operation 402). The request packet can be an ARP request associated with the gateway IP address. In the example in FIG. 1, client device 122 can send an ARP request to gateway device 112. The network device can determine the requested piece of information (operation 404). If the request is an ARP request for the gateway IP address, the piece of information can be the MAC address of the network device. The network device can then generate a packet comprising the piece of information (operation 406). If the request is an ARP request, the packet can be an ARP response that includes the MAC address of the network device. In the example in FIG. 1, upon receiving an ARP request from client device 122, network device 112 can generate an ARP response comprising the MAC address of network device 112.

FIG. 4B presents a flowchart illustrating an example of a process of a network device determining whether a packet matches a predetermined packet type, in accordance with an aspect of the present application. During operation, the network device can determine whether a packet (e.g., the packet of FIG. 3A) corresponds to a predetermined set of packet types (operation 452). These packet types can indicate whether the packet is to be distributed to other gateway devices. Examples of the predetermined packet types can include, but are not limited to, ARP responses, ping packets, PIM register requests and responses, PIM candidate RP advertisements, traceroute packets, and path MTU discovery packets. The network device can then determine whether the packet type of the packet matches one of the predetermined set of packet types (operation 454). The network device can check the protocol information in the packet (e.g., using a packet inspection tool). In the example in FIG. 2, gateway device 216 can determine whether the packet type indicated in protocol information 266 of packet 260 matches the predetermined set of packet types, as indicated in condition 254.

If the packet type matches, the network device can encapsulate the packet with an encapsulation header with the multicast IP address as the destination address (operation 456). Upon matching the packet type, the network device can determine that the packet is to be distributed to other gateway devices via the multicast group. Accordingly, the network device can set the multicast IP address as the destination IP address of the encapsulation header. Subsequently, the network device can forward the encapsulated packet based on the multicast IP address (operation 458). In the example in FIG. 2, gateway device 216 can encapsulate packet 260 with an encapsulation header 278 with multicast IP address 232 as the destination address to generate encapsulated packet 270. Gateway device 216 can then forward encapsulated packet 270 based on multicast IP address 232 to gateway devices 212 and 214 via respective tunnels. On the other hand, if the packet type does not match, the packet may not be distributed to other gateway devices. Accordingly, the network device can process the packet based on the destination IP address of the packet (operation 460). Here, the processing can include absorbing or forwarding the packet. In the example in FIG. 2, if the packet type of packet 260 does not match, gateway device 216 can forward packet 260 based on destination IP address 262.

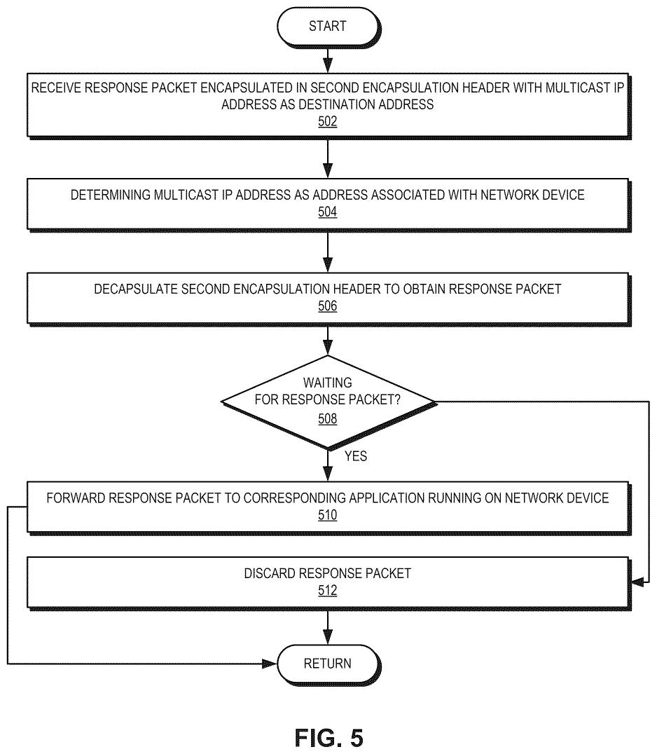

FIG. 5 presents a flowchart illustrating an example of a process of a network device receiving a packet destined to a multicast group associated with the multicast group, in accordance with an aspect of the present application. During operation, the network device can receive a response packet encapsulated in a second encapsulation header with the multicast IP address as the destination address (operation 502). Here, the network device corresponds to the network device of FIG. 3A. Therefore, the response packet can be distinct from the packet of FIG. 3A and can be the response packet to a request packet (e.g., an ARP response packet corresponding to an ARP request packet). A network may include a plurality of gateway devices, one of which can be the network device. If another gateway device determines that the response packet is to be distributed to other gateway devices, the other gateway device can send the response packet to the network device. Accordingly, the network device can receive the encapsulated response packet. In the example in FIG. 1, gateway device 112 can receive encapsulated packet 148.

The network device can determine that the multicast IP address is an address associated with the network device (operation 504). A respective gateway device can be associated with the multicast IP address. As a result, the network device can determine that the encapsulated packet is destined to the network device. In the example in FIG. 1, gateway device 112 can determine that the destination address of packet 148 is multicast IP address 132, which is associated with gateway device 112. The network device can decapsulate the second encapsulation header to obtain the response packet (operation 506). In the example in FIG. 1, gateway device 112 can decapsulate the encapsulation header of packet 148 and obtain packet 146.

The network device can then determine whether an application on the network device has been waiting for the response packet (operation 508). In particular, when the network device sends a packet, such as a ping request or an ARP request, the network device can expect a response. Accordingly, the corresponding application of the network device (e.g., the ICMP or ARP daemon) can expect a response. The network device may determine whether the application has been waiting for the response packet if a socket (e.g., a protocol socket) of the application has been waiting for the response packet. If an application on the network device has been waiting for the response packet, the network device can forward the response packet to the corresponding application running on the network device (operation 510).

In the example in FIG. 1, if an application has been waiting for packet 146, gateway device 112 can provide packet 146 to the application. However, if the application on the network device has not been waiting for the response packet, the network device may discard the response packet (operation 512). In the example in FIG. 1, if gateway device 112 pings client device 128, the ping response can be distributed to gateway devices 112 and 116. Since gateway device 116 has not pinged, the ping response may be discarded by gateway device 116.

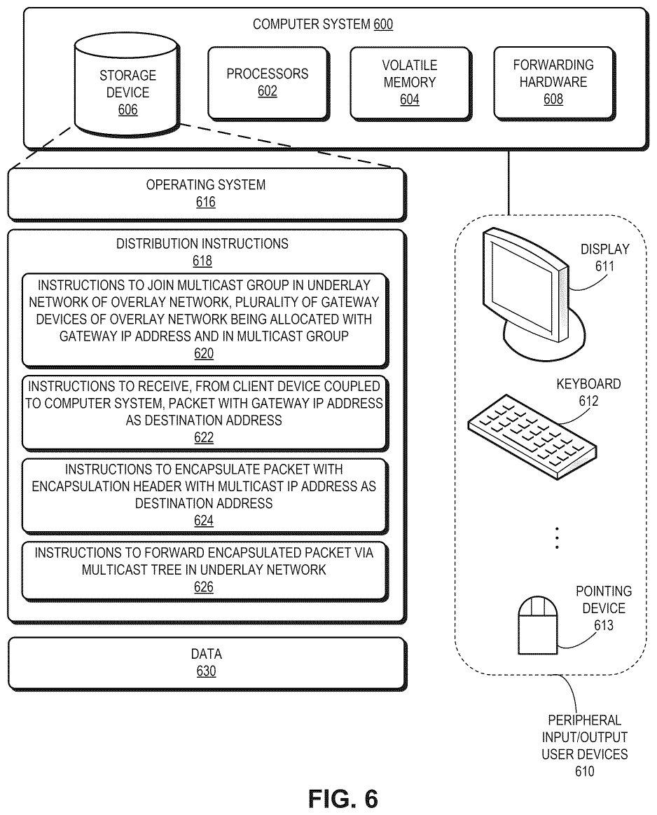

FIG. 6 illustrates an example of a computing system facilitating efficient multicast-based forwarding for a distributed gateway, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a TCAM. Storage device 606 includes a non-transitory computer-readable storage medium and stores an operating system 616, distribution instructions 618, and data 630. Computer system 600 may include fewer or more entities or instructions than those shown in FIG. 6.

Distribution instructions 618 can include instructions, which when executed by computer system 600, can cause computer system 600 to perform methods and/or processes described in this disclosure. Distribution instructions 618 can be executed on at least one of processors 602, forwarding hardware 608, or a combination thereof. Computer system 600 can be a network device in a distributed system, such as network devices 118 and 216 in FIGS. 1 and 2, respectively. Specifically, distribution instructions 618 may include instructions 620 to join a multicast group in the underlay network of an overlay network. Here, a plurality of gateway devices of the overlay network can be allocated with the gateway IP address and is in the multicast group. In the example in FIG. 1, gateway devices 112, 116, and 118 of overlay network 110 can be allocated with the same gateway IP address 130. Network device 118 can then join multicast group 140 reserved for distributing traffic in distributed gateway 150.

Distribution instructions 618 may also include instructions 622 to receive, from a client device coupled to computer system 600, a packet with a gateway IP address as a destination address. Here, computer system 600 can be coupled to the client device. In the example in FIG. 1, network device 118 can receive packet 146 from client device 128. The destination address of packet 146 can be gateway IP address 130. Furthermore, distribution instructions 618 may also include instructions 624 to encapsulate the packet with an encapsulation header with a multicast IP address of the multicast group as the destination address. In the example in FIG. 1, network device 118 can encapsulate packet 146 with an encapsulation header to generate encapsulated packet 148. The destination address of the encapsulation header can then include IP address 132 of multicast group 140.

Distribution instructions 618 may include instructions 626 to forward the encapsulated packet via a multicast tree in the underlay network. In the example in FIG. 1, gateway device 118 can forward encapsulated packet 148 via multicast tree 160. Gateway devices 112 and 116 can then receive encapsulated packet 148. Data 630 can include any data that is required as input, or that is generated as output by the methods, operations, communications, and/or processes described in this disclosure. Specifically, data 630 can include the multicast group information (e.g., multicast group 140 in FIG. 1). Data 630 can also include information identifying a respective network device in an overlay network (e.g., overlay network 110 of FIG. 1).

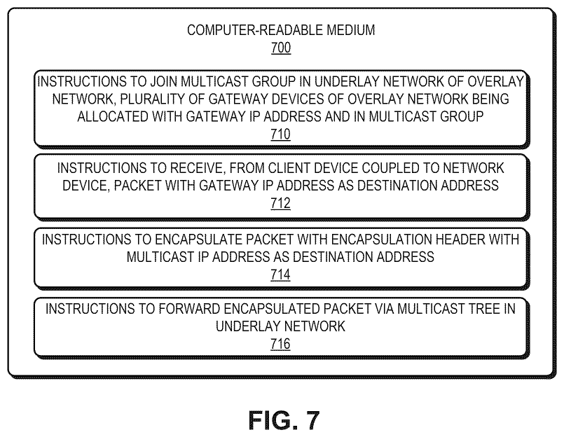

Computer system 600 and distribution instructions 618 may include more instructions than those shown in FIG. 6. For example, distribution instructions 618 can also store instructions for determining interface 162 associated with multicast group 140 of FIG. 1; allocating multicast IP address 132 to a respective gateway device of FIG. 1; decapsulating packet 148 to obtain packet 146 of FIG. 1; checking against a set of conditions to determine whether to distribute packet 260 to other gateway devices of FIG. 2; the operations depicted in the flowcharts of FIGS. 3, 4, and 5; and the instructions of non-transitory CRM 700 in FIG. 7.

FIG. 7 illustrates an example of a CRM facilitating efficient multicast-based forwarding for a distributed gateway, in accordance with an aspect of the present application. CRM 700 can include one or more non-transitory computer-readable mediums or devices storing instructions that when executed by a computer or processor cause the computer or processor to perform a method. Therefore, the instructions in CRM 700 can be stored in one or more non-transitory computer-readable mediums or devices. CRM 700 can store instructions 710 to join a multicast group in the underlay network of an overlay network. Here, a plurality of gateway devices of the overlay network can be allocated with the gateway IP address and is in the multicast group. In the example in FIG. 1, gateway devices 112, 116, and 118 of overlay network 110 can be allocated with the same gateway IP address 130. Network device 118 can then join multicast group 140 reserved for distributing traffic in distributed gateway 150.

CRM 700 can also include instructions 712 to receive, from a client device coupled to the network device, a packet with a gateway IP address as a destination address. In the example in FIG. 1, network device 118 can receive packet 146 from client device 128. The destination address of packet 146 can be gateway IP address 130. CRM 700 can include instructions 714 to encapsulate the packet with an encapsulation header with a multicast IP address of the multicast group as the destination address. In the example in FIG. 1, network device 118 can encapsulate packet 146 with an encapsulation header to generate encapsulated packet 148. The destination address of the encapsulation header can then include IP address 132 of multicast group 140. CRM 700 can also include instructions 716 to forward the encapsulated packet via a multicast tree in the underlay network. In the example in FIG. 1, gateway device 118 can forward encapsulated packet 148 via multicast tree 160.

CRM 700 may include more instructions than those shown in FIG. 7. For example, CRM 700 can also store instructions for determining interface 162 associated with multicast group 140 of FIG. 1; allocating multicast IP address 132 to a respective gateway device of FIG. 1; decapsulating packet 148 to obtain packet 146 of FIG. 1; checking against a set of conditions to determine whether to distribute packet 260 to other gateway devices of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in an overlay network. During operation, the network device can join a multicast group in an underlay network of the overlay network. Here, a gateway IP address can be allocated to a plurality of gateways of the overlay network. Furthermore, the multicast group can be associated with a multicast IP address and can include the plurality of gateways. The network device can then receive, from a client device, a packet with the gateway IP address as a destination address. The network device can then encapsulate the packet with an encapsulation header with the multicast IP address as a destination address. Subsequently, the network device can forward the encapsulated packet via a multicast tree in the underlay network.

In a variation on this aspect, to forward the encapsulated packet, the network device can determine an interface associated with the multicast group and send the encapsulated packet to the interface.

In a further variation, the interface can include multicast interface corresponding to the multicast tree in the underlay network. The encapsulated packet is distributed via the multicast tree to a respective other gateway of the plurality of gateways.

In a variation on this aspect, prior to receiving the packet, the network device can receive a request packet requesting a piece of information. The network device can then forward the request packet to the client device. Subsequently, the network device can receive the packet comprising the piece of information as a response to the request packet.

In a variation on this aspect, upon detecting the gateway IP address as the destination IP address in the packet, the network device can determine whether the packet corresponds to a predetermined set of packet types. If the packet corresponds to the predetermined set of packet types, the network device can encapsulate the packet with the encapsulation header.

In a further variation, the predetermined set of packet types can include an ARP response, an ICMP echo or response, a PIM register request or response, a PIM candidate RP advertisement, a traceroute packet, and a path MTU discovery packet.

In a variation on this aspect, the network device can receive a second packet encapsulated in a second encapsulation header with the multicast IP address as a destination address. The network device can then determine the multicast IP address as an address associated with the network device and decapsulate the second encapsulation header to obtain the second packet.

In a further variation, the network device can determine whether the network device has been waiting for the second packet. If the network device has been waiting for the second packet, the network device can forward the second packet to a corresponding application running on the network device.

In a variation on this aspect, to join the multicast group, the network device can determine that the network device is configured to be in the multicast tree in the underlay network.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an ASIC chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
joining, by a network device operating as a tunnel endpoint and a gateway in an overlay network, a multicast group in an underlay network of the overlay network, wherein a gateway IP address is allocated to a plurality of gateways of the overlay network, and wherein the multicast group is associated with a multicast IP address and includes the plurality of gateways;
receiving, from a client device coupled to the network device, a packet with the gateway IP address as a destination address;
encapsulating the packet with an encapsulation header with the multicast IP address as a destination address; and
forwarding the encapsulated packet via a multicast tree in the underlay network.

2. The method of claim 1, wherein forwarding the encapsulated packet further comprises:
determining an interface associated with the multicast group; and
sending the encapsulated packet to the interface.

3. The method of claim 2, wherein the interface includes a multicast interface corresponding to the multicast tree in the underlay network, and wherein the encapsulated packet is distributed via the multicast tree to a respective other gateway of the plurality of gateways.

4. The method of claim 1, further comprising:
receiving, prior to receiving the packet by the network device, a request packet requesting a piece of information;
forwarding the request packet to the client device; and
receiving the packet comprising the piece of information as a response to the request packet.

5. The method of claim 1, wherein, in response to detecting the gateway IP address as the destination IP address in the packet, the method further comprises:
determining whether the packet corresponds to a predetermined set of packet types; and
in response to the packet corresponding to the predetermined set of packet types, encapsulating the packet with the encapsulation header.

6. The method of claim 5, wherein the predetermined set of packet types comprises:
an Address Resolution Protocol (ARP) response;
an Internet Control Message Protocol (ICMP) echo or response;
a Protocol-Independent Multicast (PIM) register request or response;
a PIM candidate rendezvous point (RP) advertisement;
a traceroute packet; and
a path maximum transmission unit (MTU) discovery packet.

7. The method of claim 6, further comprising:
receiving a second packet encapsulated in a second encapsulation header with the multicast IP address as a destination address;
determining the multicast IP address as an address associated with the network device; and
decapsulating the second encapsulation header to obtain the second packet.

8. The method of claim 7, further comprising:
determining whether the network device has been waiting for the second packet; and
in response to the network device having been waiting for the second packet, forwarding the second packet to a corresponding application running on the network device.

9. The method of claim 1, wherein joining the multicast group further comprises determining that the network device is configured to be in the multicast tree in the underlay network.

10. A non-transitory computer-readable storage medium storing instructions to:
join, from a network device operating as a tunnel endpoint and a gateway in an overlay network, a multicast group in an underlay network of the overlay network, wherein a gateway IP address is allocated to a plurality of gateways of the overlay network, and wherein the multicast group is associated with a multicast IP address and includes the plurality of gateways;
receive, from a client device coupled to the network device, a packet with the gateway IP address as a destination address;
encapsulate the packet with an encapsulation header with the multicast IP address as a destination address; and
forward the encapsulated packet via a multicast tree in the underlay network.

11. The non-transitory computer-readable storage medium of claim 10, wherein, to forward the encapsulated packet, the instructions are further to:
determine an interface associated with the multicast group; and
send the encapsulated packet to the interface.

12. The non-transitory computer-readable storage medium of claim 11, wherein the interface includes a multicast interface corresponding to the multicast tree in the underlay network, and wherein the encapsulated packet is distributed via the multicast tree to a respective other gateway of the plurality of gateways.

13. The non-transitory computer-readable storage medium of claim 10, wherein the instructions are further to:
receive, prior to receiving the packet at the network device, a request packet requesting a piece of information;
forward the request packet to the client device; and
receive the packet comprising the piece of information as a response to the request packet.

14. The non-transitory computer-readable storage medium of claim 10, wherein, in response to detecting the gateway IP address as the destination IP address in the packet, the instructions are further to:
determine whether the packet corresponds to a predetermined set of packet types; and
in response to the packet corresponding to the predetermined set of packet types, encapsulate the packet with the encapsulation header.

15. The non-transitory computer-readable storage medium of claim 14, wherein the predetermined set of packet types comprises:
an Address Resolution Protocol (ARP) response;
an Internet Control Message Protocol (ICMP) echo or response;
a Protocol-Independent Multicast (PIM) register request or response;
a PIM candidate rendezvous point (RP) advertisement;
a traceroute packet; and
a path maximum transmission unit (MTU) discovery packet.

16. The non-transitory computer-readable storage medium of claim 10, wherein the instructions are further to:
receive a second packet encapsulated in a second encapsulation header with the multicast IP address as a destination address;
determine the multicast IP address as an address associated with the network device; and
decapsulate the second encapsulation header to obtain the second packet.

17. The non-transitory computer-readable storage medium of claim 16, wherein the instructions are further to:
determine whether the network device has been waiting for the second packet; and
in response to the network device having been waiting for the second packet, forward the second packet to a corresponding application running on the network device.

18. The non-transitory computer-readable storage medium of claim 10, wherein, to join the multicast group, the instructions are further to determine that the network device is configured to be in the multicast tree in the underlay network.

19. A computer system, comprising:
a processing resource;
a memory; and
a non-transitory computer-readable storage medium storing instructions that when executed by the processing resource cause the computer system to:
join, from a network device operating as a tunnel endpoint and a gateway in an overlay network, a multicast group in an underlay network of the overlay network, wherein a gateway IP address is allocated to a plurality of gateways of the overlay network, and wherein the multicast group is associated with a multicast IP address and includes the plurality of gateways;
receive, from a client device coupled to the network device, a packet with the gateway IP address as a destination address;
encapsulate the packet with an encapsulation header with the multicast IP address as a destination address; and
forward the encapsulated packet via a multicast tree in the underlay network.

20. The computer system of claim 19, wherein, in response to detecting the gateway IP address as the destination IP address in the packet, the instructions that when executed by the processing resource cause the computer system to:
determine whether the packet corresponds to a predetermined set of packet types; and
in response to the packet corresponding to the predetermined set of packet types, encapsulate the packet with the encapsulation header.
